(19) United States
(12) Patent Application Publication
(10) Pub. No.: US 2019/0322769 A1
(43) Pub. Date: Oct. 24, 2019

(54) Three dimensional printing with biomaterial

(71) Applicant: Teknologian tutkimuskeskus VTT Oy, Espoo (FI)

(72) Inventors: Panu Lahtinen, VTT (FI); Sini Metsä-Kortelainen, VTT (FI); Asta Nurmela, VTT (FI); Hanna Iitti, VTT (FI); Riitta Mahlberg, VTT (FI)

(21) Appl. No.: 16/469,656

(22) PCT Filed: Dec. 29, 2017
(86) PCT No.: PCT/FI2017/050955

§ 371 Date: Jun. 14, 2019

(30) Foreign Application Priority Data
Dec. 30, 2016 (FI) 20166054

(51) Int. Cl. C08B 15/00; B29C 64/165; C08K 5/053; C08L 1/02; C08L 5/04; C08J 3/075; C08J 3/24; C08K 3/30; C08K 3/32

(52) U.S. Cl. CPC C08B 15/005; B29C 64/165; C08K 5/053; C08L 1/02; B33Y 70/00; C08J 3/075; C08J 3/246; C08K 3/30; C08K 3/32; C08L 5/04

(57) ABSTRACT

According to an example aspect of the present invention, there is provided a method for producing a three-dimensional fully bio-based object by forming successive layers of biomaterial under computer control. Depending on the features necessary for the end-use application, properties of the produced 3D-object can be tailored by selecting suitable material component shares.

### FIELD

The present invention relates to materials and methods for producing bio-based three dimensionally (3D) printable objects. More precisely, the present invention relates to nanocellulose-alginate hydrogels suitable for 3D printing. Such bio-printed objects can be made either elastic or rigid and hydrophilic or hydrophobic by a proper combination of material components, based on the desired end-use.

### BACKGROUND

Three-dimensional (3D) printing refers to fabrication of objects layer by layer through deposition of material using a print head, nozzle, or another printer technology. Additive manufacturing or 3D printing technology is nowadays widely used for example in consumer, industrial, motor vehicles, aerospace and medical applications. 3D printing enables lighter structures, better performance of many products and lower production costs as separate molds and other manufacturing tools are not needed. In the medical field, the utilization of 3D printing gives many advantages especially through personalized products or mass customization.

Utilisation of biomaterials has been challenging in 3D printing due to several reasons like shrinkage, dimensional stability, adhesion and resistance to humidity. For example when alginate is mixed with water it tends to form film or hard and solid structures, which are not preferred in application areas such as wound care solutions.

It is common knowledge that in order to be suitable for 3D bio-printing, the material to be printed must be viscous enough to keep its shape during printing and have crosslinking abilities allowing for it to retain the 3D structure after printing. A typical challenge with 3D printing biomaterials is thus that the printed shapes tend to collapse due to low viscosity and solids content. Other challenges relate to post-processing and curing processes, wherein the 3D printed biomaterials tend to form hard or fragile objects when excess water is removed.

In addition, 3D printable materials for biological applications have to fulfil biological requirements such as being biocompatible and possessing low cytotoxicity. Hydrogels are attractive alternatives and natural polymers such as collagen, hyaluronic acid (HA), chitosan and alginate have been studied as 3D printable materials. Hydrogel has to be viscous enough to be 3D printable and it must have cross-linking capabilities, which allow it to retain the 3D structure after printing. Crosslinking may be induced by temperature change, UV photopolymerization or by ionic crosslinking. Common challenge is that 3D printed structures of hydrogels tend to collapse due to low viscosities (Markstedt et al., 2015).

Hydrogels are three dimensional polymer networks, which have high degree of flexibility and capability to retain a large amount of water in their swollen state (Peppas & Khare 1993, Ullah et al., 2015). Hydrogels are made of natural or synthetic materials that are crosslinked either chemically by covalent bonds, or physically by hydrogen bonding, hydrophobic interaction and ionic complexation, or by a combination of both chemical and physical crosslinking (Buwalda et al., 2014, Ullah et al., 2015). The properties of hydrogels resemble those of biological tissues and they have excellent biocompatibility because of high water content (Buwalda et al., 2014). Due to that, hydrogels also provide an ideal environment for wound healing, as it is widely accepted that maintaining a moist wound bed and skin hydration are needed for effective healing (Gainza et al., 2015).

Conventional 3D printing materials tend to release nanoparticles and gases, which may cause irritation and allergic reactions, even cancer risk to the printer users. Exposure to harmful chemicals is thus one essential problem in the existing 3D printing technology.

Thus, there is a need for safe materials and methods for 3D bio-printing of objects, which are capable of maintaining their structure after printing and fulfil biological requirements depending on their end-use.

### SUMMARY OF THE INVENTION

The invention is defined by the features of the independent claims. Some specific embodiments are defined in the dependent claims.

According to a first aspect of the present invention, there is provided a material for use in three-dimensional bio-printing, wherein combination of alginate, cellulose nanofibrils (CNF) and preferably sugar alcohol enables excellent printability and dimensional stability.

According to a second aspect of the present invention, there is provided a method for producing a three-dimensional object by forming successive layers of such material under computer control.

According to a third aspect of the present invention, there is provided a three dimensionally printed object, which is fully bio-based and applicable in multiple biocompatibility requiring end-uses.

The present invention is based on the finding that by increasing the share of non-volatile components and using an effective strength additive like CNF in the bio-based printing paste collapsing of the printed structure can be avoided. This is a common existing problem when bio-based hydrogels are printed.

These and other aspects, together with the advantages thereof over known solutions are achieved by the present invention, as hereinafter described and claimed.

More precisely, the material of the present invention is characterized by what is stated in claim 1. The method of the present invention is characterized by what is stated in claim 7. The three dimensional object of the present invention is characterized in claim 11.

Thus, the present invention discloses nanocellulose-alginate hydrogel suitable for 3D-printing. The composition of the hydrogel is optimized in terms of chemical composition by using computational modelling, material characterization methods and 3D-printing experiments. Chemical crosslinking of the hydrogel using calcium ions is found to improve the performance of the material. The resulting hydrogel is found to be suitable for 3D printing, its mechanical properties indicate good tissue compatibility, and the hydrogel is found to adsorb water in moist conditions, suggesting potential in applications such as wound dressing.

The present invention enables 3D printing of hydrogels or composites, containing organic polymer and biomaterials. The final product may be tailored depending on the requirements of the desired end-use. In addition, the printing paste is fast to produce and requires short curing times.

Next, the present technology will be described more closely with reference to certain embodiments.

### EMBODIMENTS

The present technology relates to three dimensionally (3D) printable objects that are fully bio-based and can be tailored according to the end-use application as being either elastic or rigid and either hydrophilic or hydrophobic.

The term “3D bioprinting” means producing three dimensional objects from biomaterials by using 3D printing technology.

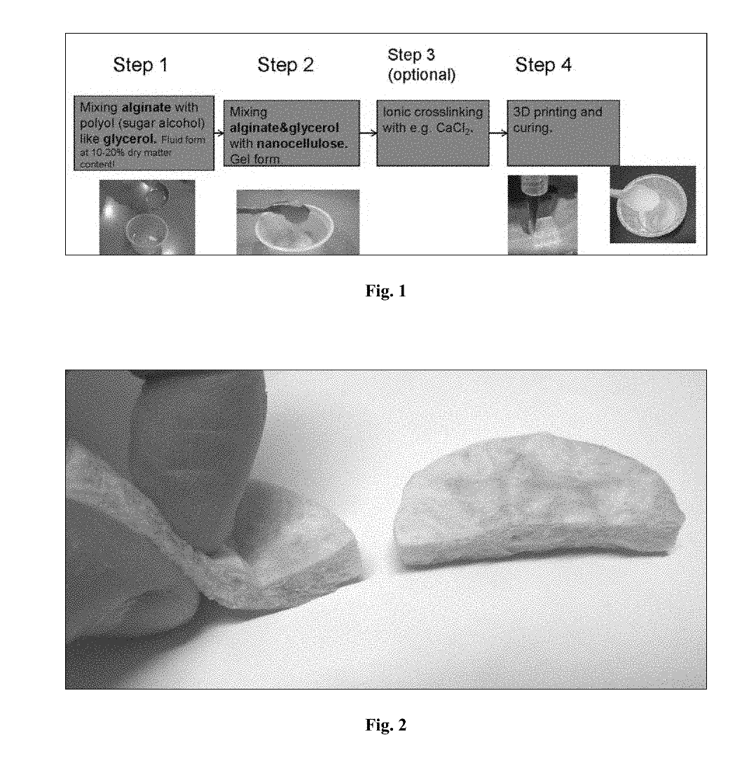

Some of the embodiments of the present invention are described in FIGS. 1 to 9.

FIG. 1 is a process scheme showing possible steps of one suitable method of the present invention.

FIG. 2 is a photo showing a freeze-dried sample of alginate-nanocellulose-glycerol mixture, forming flexible foam.

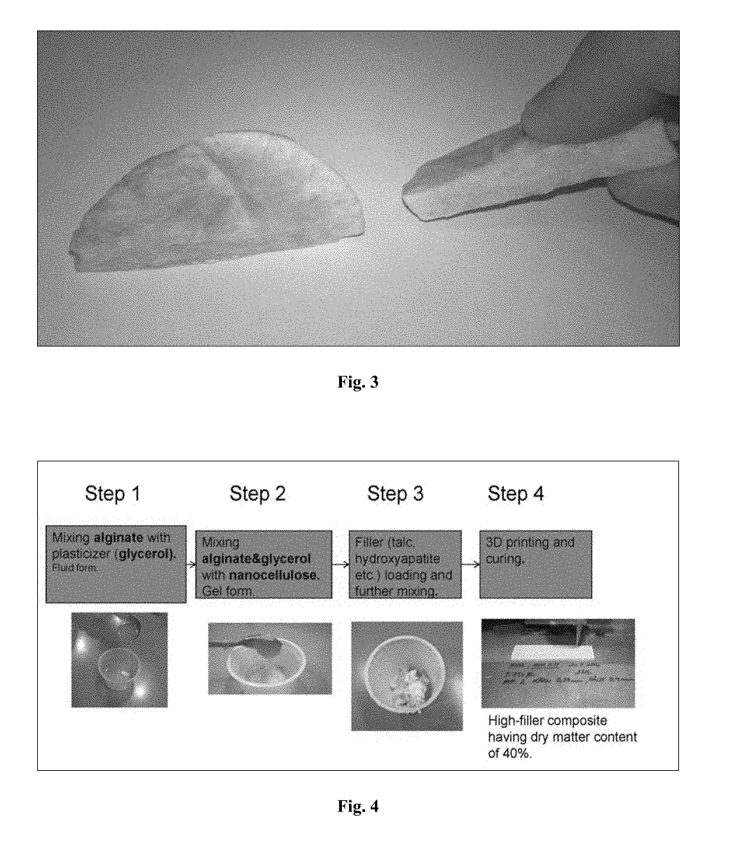

FIG. 3 is photo showing a freeze-dried, cross-linked and further freeze-dried sample of alginate-nanocellulose-glycerol mixture, forming rigid foam.

FIG. 4 is another possible process scheme of the present invention, describing high-filler loading.

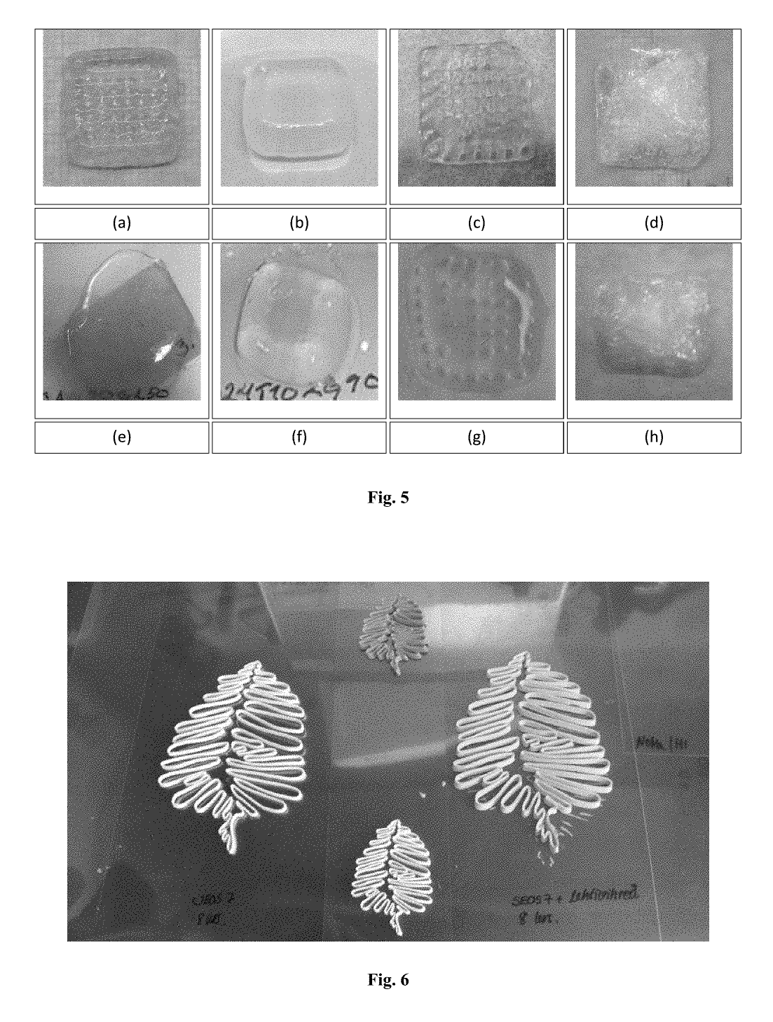

FIG. 5 shows images of the printed structures: (a) alginate-TCNF-glycerine, non-cross-linked before the humidity test, (b) alginate-TCNF-glycerine, cross-linked before the humidity test, (c) alginate-TCNF-glycerine, freeze-dried before the humidity test, (d) TCNF before the humidity test, (e) alginate-TCNF-glycerine, not crosslinked, after 4 days of testing, (f) alginate-TCNF-glycerine, cross-linked, after 4 days of testing, (g) freeze-dried after 4 days of testing, (h) TCNF reference after 4 days of testing.

FIG. 6 shows images of 3D printed decorative elements with dyes.

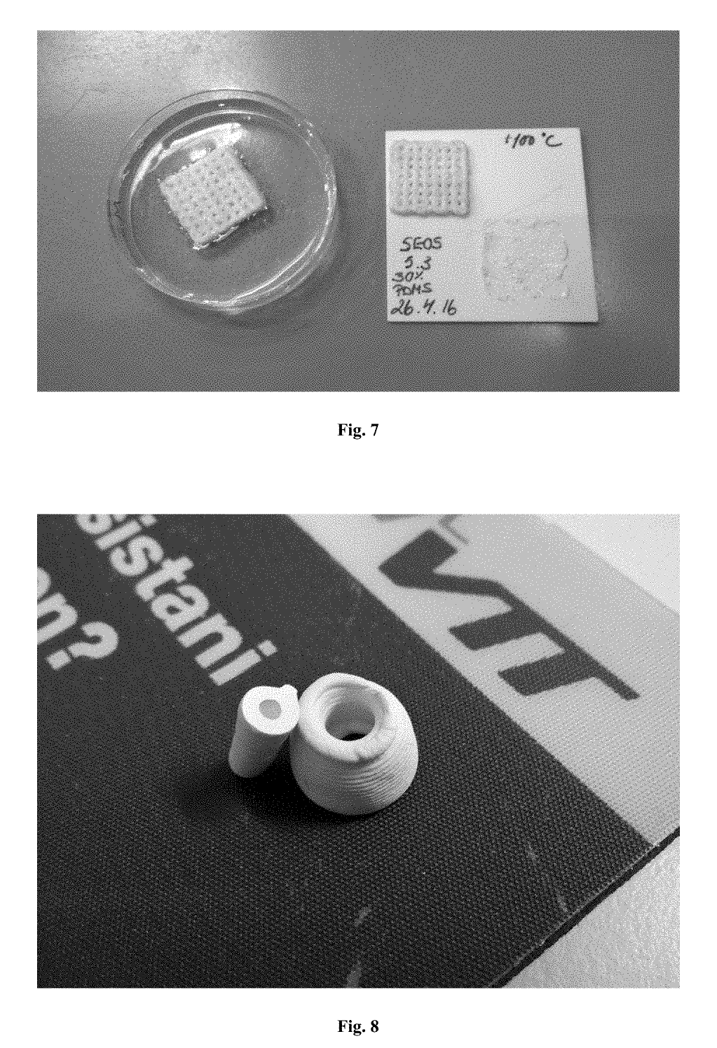

FIG. 7 shows images of elastic and hydrophobic high-filler structures.

FIG. 8 shows images of printed implants for a mouse trachea.

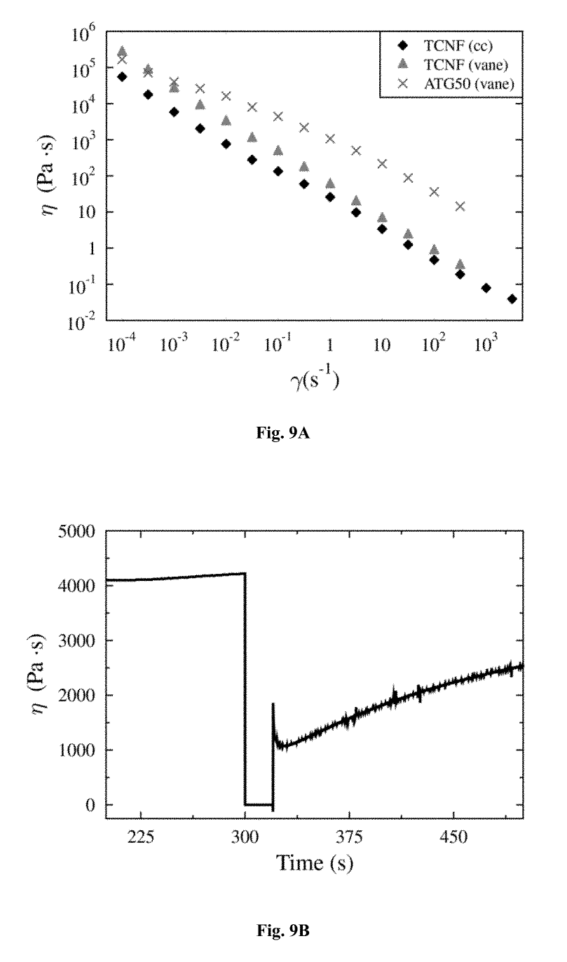

FIG. 9A is a diagram showing steady state viscosity as a function of shear rate in the rheometry experiments. FIG. 9B is a diagram showing thixotropic behaviour of viscosity during a shear-rate transient. Herein the sample was pre-sheared at 0.01 s⁻¹ until a steady state was reached (0-300 s). Shear-rate was then suddenly increased to 316 s⁻¹, and kept there for 20 s (300-320 s). After this, the shear rate was suddenly reset to the original value of 0.01 s⁻¹.

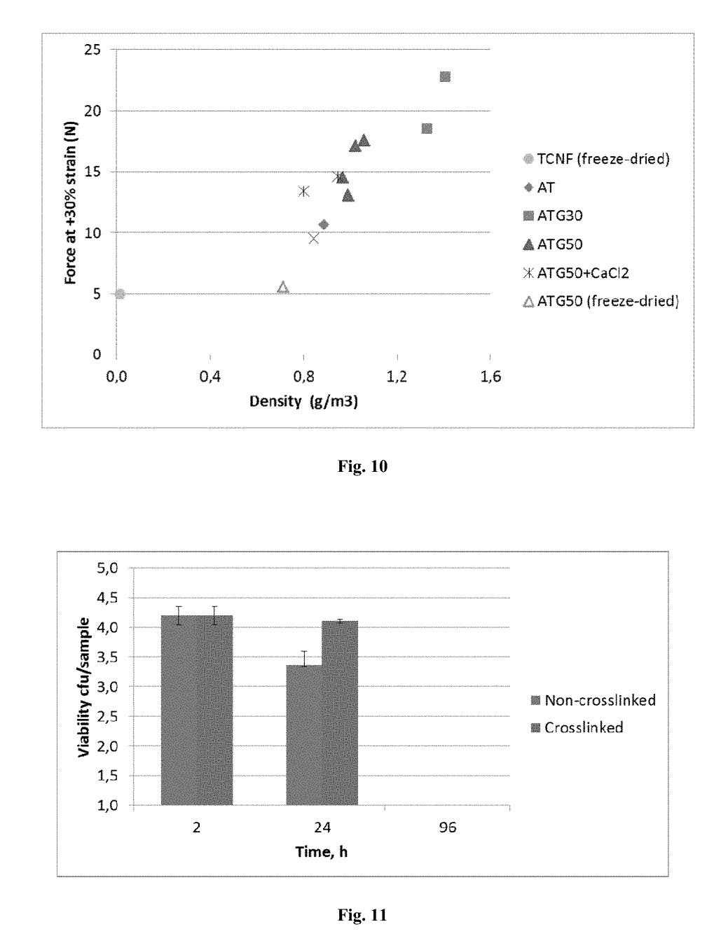

FIG. 10 is a diagram relating to compression measurements and shows the compressive strain values of samples of different material compositions before crosslinking.

FIG. 11 is a diagram showing viability of cells in non-cross-linked and cross-linked samples.

Thus, one aspect of the present invention is a method for producing a three-dimensional object by forming successive layers of material under computer control, wherein the material forming the object is 100% bio-based and comprises 1 to 30 weight-% of nanocellulose of the dry matter as a strength enhancer. In addition to nanocellulose, the material preferably comprises 5 to 95% of the total volume of sugar alcohol as a plasticizer, preferably glycerol or its derivative, such as polyglycerol or triacetine.

According to one embodiment of the present invention, nanocellulose can be made from wood-based or non-wood materials, for example from hemp fibres.

According to one embodiment, the share of glycerol is 40 to 70% of the total volume. The higher amount of glycerol and nanocellulose prevent collapsing of 3D printed shape, when the material mixture is printed and further cured or dried.

Thus, according to an embodiment of the present invention, the method includes the steps of:
(a) optionally mixing an alginate as a rheology modifier with the sugar alcohol to form a fluid,
(b) mixing the formed fluid or polyvinyl alcohol with nanocellulose to form a hydrogel,
(c) optionally carrying out ionic cross-linking with a cross-linking agent, such as CaCl₂,
(d) bio-printing the desired three-dimensional object, and
(e) curing the printed object in room temperature, or in an oven at temperatures between 100° C. and 150° C., or by freeze-drying.

It is essential that the alginate is first mixed or dispersed into a medium, which is not water. Especially sugar alcohol such as glycerol is preferred, because it does not form thick gels unlike water. This enables higher dry matter concentration and production of even quality paste. Nanocellulose is then added after the alginate has been dispersed, and final dry matter content and paste thickness of the paste can be tailored with suitable filler, such as talc. Mixing alginate with water causes immediate cross-linking and prevents formation of evenly dispersed printable paste.

According to one embodiment of the present invention, 10 to 49 weight-% of polyvinyl alcohol instead of alginate is used, whereby the hydrogel is produced from polyvinyl alcohol, nanocellulose and possible filler. Polyvinyl alcohol has the advantage of being affordable material and resulting in more elastic and mechanically stronger end-products compared to alginate. Also, it results less shrinking for the end-product when dried and increased dry matter content. Polyvinyl alcohol fluid acts as a rheology modifier instead of alginate when used at high solids content (such as over 30 weight-%). By this way, the viscosity of the printing paste can be increased according to the needs and/or requirements of the 3D-printing.

Bio-printing of the three dimensional object is carried out by a 3D printer comprising instructions for the desired end-shape of the object, i.e. by direct write printing.

When freeze-drying is used for curing, the object becomes porous and can absorb liquid over 20 times of its weight. This feature is especially useful in wound care and wound healing applications.

According to a further embodiment of the present invention, the material comprises filler, selected from talc, hydroxyapatite or tri-calcium phosphate.

According to even further embodiment, step (c) is replaced by filler loading, wherein the material comprises up to 90 weight-% dry matter of suitable filler.

Thus, one embodiment of the present invention is a method for producing high-filler hydrogel composite for 3D-printing. The method includes at least the steps of:
(a) optionally mixing an alginate with a plasticizer, such as glycerol, to form a fluid,
(b) mixing the formed alginate and plasticizer comprising fluid or polyvinyl alcohol with nanocellulose to form a gel,
(c) loading filler, such as talc or hydroxyapatite, and further mixing of the gel mixture,
(d) bio-printing the desired three-dimensional object, and
(f) curing the printed object in room temperature, or in an oven at elevated temperatures between 100° C. and 150° C., or by freeze-drying.

Some advantageous properties of the printed high-filler composite are for example that the material is elastic and can be bent without breaking the object. In addition, the formed structure is reversible and can be made more rigid by adding nanocellulose into the mixture. Such printed object can also include other desired components, such as dyes, and components possessing electrical and magnetic properties.

According to one embodiment, the high-filler composite contains 89 wt-% of talc, 10 wt-% of alginate and 1 wt-% of hemp-based nanocellulose. The amount of glycerol is 7% of the total volume.

In the present context several bio-based hydrogel compositions were benchmarked to be used as a printing paste for 3D printing. Combination of alginate, cellulose nanofibrils and glycerine enabled excellent printability and dimensional stability at room temperature. By increasing the share of non-volatile components and using an effective strength additive like CNF in the bio-based printing paste collapsing can be avoided. This is a common problem when bio-based hydrogels are printed. The paste should flow through the printing nozzle and retain its 3D shape after printing and curing.

One embodiment of the present invention is a three dimensionally printed object, wherein the material is 100% bio-based and comprises 10 to 20 weight-% of an alginate and 1 to 30 weight-% of nanocellulose of the dry matter.

According to a further embodiment the three dimensionally printed object comprises 5 to 95 weight-% of sugar alcohol, in particular glycerol or its derivative.

Both terms “glycerol” and “glycerine” are used in the present context interchangeably.

It is to be understood that the embodiments of the invention disclosed are not limited to the particular structures, process steps, or materials disclosed herein, but are extended to equivalents thereof as would be recognized by those ordinarily skilled in the relevant arts. It should also be understood that terminology employed herein is used for the purpose of describing particular embodiments only and is not intended to be limiting.

Reference throughout this specification to one embodiment or an embodiment means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment. Where reference is made to a numerical value using a term such as, for example, about or substantially, the exact numerical value is also disclosed.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. In addition, various embodiments and example of the present invention may be referred to herein along with alternatives for the various components thereof. It is understood that such embodiments, examples, and alternatives are not to be construed as de facto equivalents of one another, but are to be considered as separate and autonomous representations of the present invention.

Furthermore, the described features, structures, or characteristics may be combined in any suitable manner in one or more embodiments. In the following description, numerous specific details are provided to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

The verbs “to comprise” and “to include” are used in this document as open limitations that neither exclude nor require the existence of also un-recited features. The features recited in depending claims are mutually freely combinable unless otherwise explicitly stated. Furthermore, it is to be understood that the use of “a” or “an”, that is, a singular form, throughout this document does not exclude a plurality.

### INDUSTRIAL APPLICABILITY

At least some embodiments of the present invention find industrial application for example in areas relating to prototyping, biomedical applications, tissue engineering, wound healing and other fields that utilize three dimensionally printable bio-based objects. The mechanical properties of the developed materials indicate good tissue compatibility. For example, the hydrogel adsorbs water in moist conditions, enabling potential in applications such as wound dressing. The 3D printable nanocellulose-alginate hydrogel offers a platform for development of biomedical devices, wearable sensors and drug releasing materials. Furthermore, 3D printing enables lighter structures, better performance of many products and lower production costs as separate molds and other manufacturing tools are not needed. In the medical field, the utilization of 3D printing gives many advantages especially through personalized products or mass customization. he medical sector is using 3D printing for fabrication of models, surgical cutting or drill guides and different kinds of implants.

### EXAMPLE 1

### Materials Used

TEMPO-oxidised cellulose nanofibrils (TCNF) were produced from never-dried bleached hardwood kraft pulp from Finland. 2,2,6,6-tetramethylpiperidine-1-oxyl (TEMPO)—mediated oxidation was carried out as a chemical pre-treatment according to method applied by Saito&al. (Saito et al. 2006). The sample size was 300 g and the pulp was suspended in 301 of purified water. TEMPO (0.1 mmol/g) and NaBr (1 mmol/g) were used to catalyse the oxidation reaction with NaClO (5 mmol/g). The pH was kept at 10 by adding 1M NaOH during the reaction. When the pH level stabilized the reaction was stopped by adding ethanol into the oxidized pulp suspension. Finally the pH was adjusted to 7 by the addition of 1M HCl. The oxidized pulp was washed with deionized water by filtration and stored in a fridge at +6° C. before fibrillation.

The oxidized pulp was soaked at 1% solids and dispersed using a high-shear Ystral X50/10 Dispermix mixer for 10 minutes at 2000 rpm. The pulp suspension was then fed into Microfluidics' microfluidizer type M110-EH at 1850 bar pressure. The suspension went twice through the chambers having a diameter of 400 and 100 μm. The final product formed a viscous and transparent hydrogel with a final dry material content of 1.06% and a charge value of 1.1 mmol/g dry pulp.

Sodium alginate (E401) was provided by Cargill as a light-brown powder. The alginate type was Algogel 3541 and had a medium M/G ratio (-0.7-0.8). An aqueous solution of CaCl₂ (90 mM) was used as the cross-linking solution for the printed structures. Glycerol (Glycerine 99.5% AnalaR NORMAPUR) was purchased from VWR International.

Preparation of Hydrogels

Several formulations of the printing pastes were prepared from pure TCNF and a mixture of TCNF, alginate and glycerine. The selected pastes can be seen in Table 1. The aim of the preliminary trials was to formulate pastes that have good enough viscoelastic properties so that they would flow thought the nozzle and retain their structure after being deposited.

Also the aim was to increase volume and the share of non-volatile components so that excessive shrinkage could be minimized and the specimen would retain their shape after being cured. For this reason part of water was replaced with other medium, which in this case was glycerine. After the preliminary trials four pastes with different compositions were selected for further evaluation.

TCNF was used as a reference gel in its original consistency of 1.06%. When glycerine was not used alginate powder was mixed directly with TCNF. The powder was added gradually into the hydrogel while intensively mixing the paste with a spoon for a couple of minutes. When glycerine was used the alginate powder was first mixed with glycerine until a smooth and low viscous fluid was achieved. Then TCNF was added into the mixture and blended rapidly. In less than 30 seconds the mixture became an exceptionally viscous paste. All the pastes were stored in a fridge at 6° C. before 3D printing.

TABLE 1
Composition of printing pastes.

| | Alginate/TCNF | Water | Glycerine |
|---|---|---|---|
| Sample ID | (w/w) | (% w/v) | (% w/v) |
| T | 0/100 | 99 | 0 |
| AT | 66/33 | 96 | 0 |
| ATG30 | 85/15 | 65 | 30 |
| ATG50 | 90/10 | 45 | 50 |

3D Printing

The VTT's micro-dispensing environment based on nScrypt technology was used in the 3D printing of hydrogels containing different proportions of TCNF, alginate and glycerine. The 3D structures were built up in a layer-by-layer approach utilising a CAD controlled xyz-motion control system in guiding the tip position. The 3D printing facilities consists of several different types of pumps which enable the 3D printing of materials with versatile rheologies. In these trials, a simplified pump system was used and it was based on an air pressure controlled dispensing of the hydrogels through a tip on a plastic substrate.

Before the 3D printing, the hydrogels with different formulations were inserted to 3 ml syringes which were placed on a speed mixer (SpeedMixer™ DAC 150 SP) for 2-8 minutes before the 3D printing for removing the air bubbles from the samples and ensuring the uniformity of the pastes. For the development of hydrogel formulations, the printability of the materials and the stability of the 3D printed structures were studied in a qualitative manner. The target was to create a good flow of the hydrogels through the printing tip by adjusting several printing parameters as air pressure, speed, height of the tip from the substrate, distance between the layers and selection of the size, shape and material of the tip.

Conditioning Testing

The moisture uptake and swelling behaviour of the materials developed were evaluated by measuring the mass and dimensional changes of 3D printed specimens when stored at 90% relative humidity (RH). The 3D printed structures of the TCNF-alginate-glycerine hydrogel (with and without CaCO₃ cross-linking) were placed in a humidity room of 50% (23±2° C.) and stored under these conditions until the equilibrium weight was reached. As reference specimens, 3D structures made from the TCNF hydrogel were used. After printing, these reference structures were freeze-dried in order to prevent the structures from collapsing. After drying, the TCNF reference specimens were moved to the 50% RH and conditioned to the equilibrium moisture content. After the conditioning at 50% RH, the specimens were moved to the 95% RH and the mass and volume measurements were frequently carried out (3 times a day at the minimum).

The dimensional measurements were carried out by means of a digital vernier gauge with 0.01 mm accuracy.

Compression Measurements

Compression measurements were performed with a texture analyzer TA.XT.-Plus Texture Analyzer and Exponent software at room temperature. Tests were performed on casted discs and printed square grids, which were conditioned before the tests at 50% relative humidity and 23° C. Freeze-dried grids were prepared from both the TCNF and AGT50 samples. The discs had a diameter of 25 mm and height varied between 4-7 mm. The length of the grid side was between 17-19 mm and height 5 mm. The samples were compressed until 30-70% compressive strain was achieved after having reached a trigger load of 1 g. Some sample discs had a convex surface and thus they were compressed until 70% strain. Also due to the uneven shape of the test specimen the compression force at 30% strain was plotted as a function of the sample density.

Compressive strain values are presented in FIG. 10. The results clearly show that post-treatment has an effect on compressibility. The freeze-dried samples TCNF and ATG50 were softer and spongier. Especially TCNF was foamy after freeze-drying and thus compressed easily. The compressive force needed for 30% compressive strain was around 5 N, while the other samples needed approximately 10 N or more. This was clearly connected to high moisture uptake and dimensional changes with the freeze-dried ATG50. Otherwise the compressive force correlated with density and no clear relation to the amount of glycerine was noticed. The cross-linked sample ATG50+CaCl₂ had slightly lower compression force at 30% strain, but at the same time it had lower density. The cross-linking created a dense film around the sample and thus, drying was restricted. The cross-linked sample ATG5O+CaCl₂ had more rubber-like surface compared to the ATG50.

Rheometry

Rheometry experiments were used to determine the rheological behavior of the printing pastes. The main focus was on the dependence of dynamic viscosity on the shearing conditions, both steady-state and transient. The measurements were carried out using an Anton Paar MCR 301 rheometer with (i) vane spindle and cylindrical cup, and (ii) concentric cylinder (CC) geometries. Vane spindles are used to prevent wall slip, which typically causes problems with gel-like samples. On the other hand, the geometry of the shear region is not well defined and thus the calculated shear rates and stresses are not as precise as with other measuring geometries. The maximum shear rate with the vane spindle and cylindrical cup geometry was 316 s⁻¹. With the CC geometry, the range could be extended to 3160 s⁻¹. The minimum shear rate was 10⁻⁴ s⁻¹ for both geometries. In the steady-state experiments, each shearing condition was sampled for at least 200 seconds so that the dynamic viscosity would have converged. As a rule of thumb, the measuring point duration should be at least as long as the reciprocal of shear rate (Mezger 2011). This rule was not followed for the lowest shear rates, for which it implies sampling times of over two hours. The steady-state viscosities were obtained by averaging over the last 20 measured values (i.e. 20 seconds at 1 Hz sampling frequency) at each shear rate. In the transient experiments, the response of the dynamic viscosity to shear rate steps was determined. Furthermore, capillary viscosimetry was used to verify the limiting (steady-state) behavior at very high shear rates.

### EXAMPLE 2

Materials Used

TEMPO-oxidized cellulose nanofibrils (TCNF) were produced from never-dried bleached hemp pulp according to the method described in Example 1. The hemp pulp was produced by soda cooking and the pulp was bleached using the bleaching sequence D-E₍ₚ₎-D. Sulphur acid or NaOH was used for pH adjustment before chlorine dioxide charging. Peroxide was used to improve brightness. After every bleaching stage the pulp was washed several times with deionized water and after the last bleaching stage the pulp pH was adjusting to 4.5 with SO₂ for equalizing pH level and for terminating residual chlorine dioxide.

The alginate type was Algogel 3541 and had a medium M/G ratio (˜0.7-0.8). Glycerine was the same (Glycerine 99.5% AnalaR NORMAPUR) as in Example 1. Talc was Finntalc P 60. In this solution silicon-based organic polymer polydimethylsiloxane (PDMS) was used together with biomaterials to produce a 3D printable paste, which forms elastic and hydrophobic structures.

Preparation of Hydrogels

Different formulations of the printing pastes were prepared from a mixture of talc, alginate, TCNF, PDMS and glycerine. The selected pastes can be seen in

TABLE 2
The aim of the trials was to formulate high-filler pastes that can
be used for producing both rigid and elastic and more hydrophobic
structures for decorative elements. For this reason part of water was
replaced with glycerine and one paste was loaded with 30 vol-%
PDMS. After the preliminary trials four pastes with different
compositions were selected for further evaluation.
Composition of printing pastes including additives.

| | Alginate | Talc | TCNF | Glycerine | PDMS | Water | Total solids |
|---|---|---|---|---|---|---|---|
| Paste | (%) | (%) | (%) | (%) | (%) | (%) | (%) |
| 1 | 4.0 | 36.0 | — | — | — | 60 | 40 |
| 2 | 4.0 | 35.6 | 0.4 | 10 | — | 50 | 40 |
| 3 | 3.4 | 30.3 | 0.3 | — | 30 | 36 | 34 |
| 4 | 3.9 | 38.7 | 0.4 | — | — | 57 | 43 |

A mixture of talc and alginate was used as a reference gel in the consistency of 40 wt %. When glycerine was not used alginate powder was first mixed with talc powder and then the powder mixture was mixed with TCNF. The powder was added gradually into the hydrogel while intensively mixing the paste with a spoon for a couple of minutes. When glycerine was used the alginate powder was first mixed with glycerine until a smooth and low viscous fluid was achieved. Then TCNF was added into the mixture and blended rapidly. In less than 30 seconds the mixture became an exceptionally viscous paste. In the final step the filler was mixed gradually into the paste until a viscous and high-filler paste was formed. All the pastes were stored in a fridge at 6° C. before 3D printing.

Printing Paste Preparation by Using PVA

PVA (Kuraray Poval grades) was cooked in 1% CNF suspension 60 minutes in continuous high-shear mixing at temperature of 95 to 97° C. Mixture solids were: Poval 3-85+CNF: 58 wt % (1% of CNF, 57% of PVA from total solids) and Poval 6-88+CNF: 37 wt % (1% of CNF, 36% of PVA from total solids).

3D Printing

The VTT's micro-dispensing environment based on nScrypt technology was used in the 3D printing of hydrogels containing different proportions of TCNF, alginate (or PVA), talc, PDMS and glycerine (FIGS. 6-8). The 3D structures were built up in a layer-by-layer approach utilising a CAD controlled xyz-motion control system in guiding the tip position. Samples for mechanical strength measurements were produced using spiral shape and zz-shape printing in order to test the effect of dispensing pattern on the mechanical strength of the objects. Some pastes were also further dyed with green food dye and 3D printed leafs were produced (FIG. 6).

Mechanical Strength Measurements

Tensile tests were performed according to ISO 527 standard using an Instron 4505 Universal Tensile Tester (Instron Corp., Canton, Mass., USA) and an Instron 2665 Series High Resolution Digital Automatic Extensometer (Instron Corp., Canton, Mass., USA) with a 1 kN load cell and a 2 mm/min cross-head speed. The samples were printed to small dog bone shape according to ISO 527-2 type 5. The results are presented in Tables 3 and 4 below.

TABLE 3
Spiral shape printing.

| | | | Tensile | |
|---|---|---|---|---|
| | | Modulus | stress | Strain |
| Paste | Composition | (MPa) | (kPa) | (%) |
| 1 | Talc + alginate | 1091 | 6802 | 1.91 |
| 2 | Talc + alginate + TCNF + glycerine | 72 | 2047 | 7.68 |
| 3 | Talc + alginate + TCNF + PDMS | 12 | 624 | 19.84 |
| 4 | Talc + alginate + TCNF | 1189 | 6018 | 0.82 |

TABLE 4
ZZ-shape printing.

| | | | Tensile | |
|---|---|---|---|---|
| | | Modulus | stress | Strain |
| Paste | Composition | (MPa) | (kPa) | (%) |
| 1 | Talc + alginate | 628 | 319 | 0.17 |
| 2 | Talc + alginate + TCNF + | 64 | 1460 | 5.34 |
| | glycerine | | | |
| 3 | Talc + alginate + TCNF + PDMS | 12 | 585 | 15.59 |
| 4 | Talc + alginate + TCNF | No data | No data | No data |

TABLE 5
Moulded samples.

| | | | Tensile | |
|---|---|---|---|---|
| | | Modulus | stress | Strain |
| Paste | Composition | (MPa) | (kPa) | (%) |
| 1 | Talc + alginate | No data | No data | No data |
| 2 | Talc + PVA + TCNF | 204 | 3560 | 2.2 |
| 3 | Talc + alginate + TCNF + sorbitol | 84 | 3720 | 13.7 |

### EXAMPLE 3

Materials Used

Hydrogel (ATG50) containing 50% glycerin, 45% nanocellulose (TEMPO-oxidized CNF) and 5% alginate. The total dry matter content was 5.1% of which 90% alginate and 10% TCNF. Six replicate samples (total number of samples was 12) was prepared comprising non cross-linked samples and samples cross-linked with CaCl₂ solution (90 mM).

Preparation of Samples

Samples were prepared by the methods described in patent applications WO 2016/097488 and FI 20166020.

Adhesion of Bacteria

Adhesion and survival of Staphylococcus aureus VTT E-70045 and Pseudomonas aeruginosa VTT E-84219 on the hydrogel samples was examined in physiological salt solution at 37° C. Overnight grown cultures were harvested by centrifugation, suspended in physiological salt solution and diluted. Inoculum level of the cells in the experiment was 10⁵ cells/sample. Hydrogels were melted in wells and the inoculum was added as droplets on the surface of the samples (10⁵ cells/sample). Samples were incubated at 37° C. (2 h, 1 d, 4 d sampling). After incubation the number of cells from hydrogel samples were analyzed with culture based methods. Cells from the samples were released with Stomacher homogenizator.

Results and Conclusions

Survival of the cells on the non-cross-linked surface was poorer compared to the cross-linked hydrogel. After four day incubation part of the cell death caused by drying of the cells on the surface of the samples. The results are shown in FIG. 11.

### CITATION LIST

### Patent Literature

WO 2016/097488

FI 20166020

### Non-Patent Literature

1. Markstedt, K., Mantas, A., Tournier, I., Martinez Avila, H., Hagg, D. & Gatenholm, P. 2015, “3D Bioprinting Human Chondrocytes with Nanocellulose-Alginate Bioink for Cartilage Tissue Engineering Applications”, Biomacromolecules, vol. 16, no. 5, pp. 1489-1496.
2. Peppas, N. A. & Khare, A. R. 1993, “Preparation, structure and diffusional behavior of hydrogels in controlled release”, Advanced Drug Delivery Reviews, vol. 11, no. 1-2, pp. 1-35.
3. Ullah, F., Othman, M. B. H., Javed, F., Ahmad, Z. & Akil, H. M. 2015, “Classification, processing and application of hydrogels: A review”, Materials Science and Engineering: C, vol. 57, pp. 414-433.
4. Buwalda, S. J., Boere, K. W. M., Dijkstra, P. J., Feijen, J., Vermonden, T. & Hennink, W. E. 2014, “Hydrogels in a historical perspective: From simple networks to smart materials”, Journal of Controlled Release, vol. 190, pp. 254-273.
5. Gainza, G., Villullas, S., Pedraz, J. L., Hernandez, R. M. & Igartua, M. 2015, “Advances in drug delivery systems (DDSs) to release growth factors for wound healing and skin regeneration”, Nanomedicine: nanotechnology, biology, and medicine, vol. 11, no. 6, pp. 1551-1573.

1. A material for three-dimensional printing, wherein the material is 100% bio-based and comprises 10 to 20 weight-% of an alginate and 1 to 30 weight-% of nanocellulose of a dry matter of the material.

2. The material according to claim 1, further comprising 5 to 95 weight-% of sugar alcohol.

3. The material according to claim 1, further comprising 40 to 70 weight-% of glycerol, polyglycerol, or triacetin.

4. The material according to claim 1, further comprising a filler selected from the group consisting of talc, hydroxyapatite, and tri-calcium phosphate.

5. (canceled)

6. The material according to claim 1, wherein the material has antimicrobial properties.

7. A method for producing a three-dimensional object comprising forming successive layers of the material according to claim 1 under computer control.

8. The method according to claim 7, further comprising:
(a) optionally mixing an alginate with a sugar alcohol to form a fluid mixture,
(b) mixing the formed fluid mixture if formed or otherwise polyvinyl alcohol with nanocellulose to form a hydrogel,
(c) optionally carrying out ionic cross-linking of the hydrogel with a cross-linking agent,
(d) bio-printing a three-dimensional object from the hydrogel, and
(e) curing the bio-printed three-dimensional object at room temperature, in an oven at temperatures between 100° C. and 150° C., or by freeze-drying.

9. The method according to claim 7, wherein step (c) is not performed and is replaced by filler loading, after which the material comprises up to 90 weight-% dry matter of a filler, and wherein the filler is selected from the group consisting of talc, hydroxyapatite, and tri-calcium phosphate.

10. The method according to claim 7, wherein step(a) is performed, and wherein the alginate is mixed with glycerol to form the fluid mixture in step (a).

11. A three dimensionally printed object formed from the material of claim 1.

12. The three dimensionally printed object according to claim 11, further comprising 5 to 95 weight-% of a sugar alcohol.

13. A three dimensionally printed object, wherein the material is bio-based and comprises 10 to 49 weight-% of polyvinyl alcohol and 1 to 30 weight-% of nanocellulose of a dry matter of the object.

14. (canceled)

15. (canceled)
